(19) United States
(12) Patent Application Publication
(10) Pub. No.: US 2023/0269071 A1
(43) Pub. Date: Aug. 24, 2023

(54) SYSTEM AND METHOD FOR ENCRYPTION WITH EVOLVING MATURE KEY

(71) Applicant: Jerry Wickey, Fort Wayne, IN (US)

(72) Inventor: Jerry Wickey, Fort Wayne, IN (US)

(21) Appl. No.: 18/111,409

(22) Filed: Feb. 17, 2023

Related U.S. Application Data
(60) Provisional application No. 63/311,772, filed on Feb. 18, 2022.

(51) Int. Cl. H04L 9/06; H04L 9/08

(52) U.S. Cl. CPC H04L 9/0618; H04L 9/0861; H04L 9/0891

(57) ABSTRACT

A system and method for encrypting communications is configured to perform authentication and verification of plain text as a byproduct of decryption. This mitigates the need to use asymmetric key encryption or other authentication features that would substantially and negatively impact the transaction speed, processor use, and network use during encrypted communications. Further, since the authentication process can be performed incidental to the decryption process, there is little or no negative impact on computational resources.

### PRIORITY

This application claims priority to U.S. Provisional App. 63/311,772, filed Feb. 18, 2022, titled “SYSTEM AND METHOD FOR ENCRYPTION WITH EVOLVING MATURE KEY,” the entire disclosure of which is hereby incorporated by reference herein.

### FIELD

The disclosed technology pertains to a system and method for encrypted communication.

### BACKGROUND

Implementations of the disclosed technology address technical shortcomings of conventional encryption by providing authentication and verification of the contents of encrypted messages, which may be encrypted by varying cipher methods (e.g., streaming cipher, block cipher), without adding additional processes or steps that are burdensome both in time and processing power.

Current challenges to conventional encryption include a need for asymmetric and other forms of independent authentication and verification, which can substantially and negatively impact speed of communication and use of computational resources. What is needed, therefore, is an improved system for encrypted communication.

### BRIEF DESCRIPTION OF THE DRAWINGS

The drawings and detailed description that follow are intended to be merely illustrative and are not intended to limit the scope of the invention as contemplated by the inventors.

FIG. 1 is a flowchart illustrating a conventional approach for providing encrypted communication with a streaming cipher.

FIG. 2 is a flowchart a conventional approach for providing encrypted communication with a block cipher.

FIG. 3 is a flowchart showing a set of steps that may be performed with a system to provide encrypted communication with a streaming cipher including an evolving mature key.

FIG. 4 is a flowchart showing a set of steps that may be performed with a system to provide encrypted communication with a block cipher including an evolving mature key.

FIG. 5A illustrates a set of inputs and outputs from a first transmitted portion of encrypted data.

FIG. 5B illustrates a set of inputs and outputs from a second transmitted portion of encrypted data.

FIG. 6 illustrates a set of steps performed by the sender and the recipient to an encrypted communication.

### DETAILED DESCRIPTION

The inventors have conceived of novel technology that, for the purpose of illustration, is disclosed herein as applied in the context of encrypted communication. While the disclosed applications of the inventors’ technology satisfy a long-felt but unmet need in the art of encrypted communication, it should be understood that the inventors’ technology is not limited to being implemented in the precise manners set forth herein, but could be implemented in other manners without undue experimentation by those of ordinary skill in the art in light of this disclosure. Accordingly, the examples set forth herein should be understood as being illustrative only, and should not be treated as limiting.

Implementations of the disclosed technology represent substantial enhancements and improvements to modern encryption, which include methods for completing all of the necessary functions of authentication and verification in the processes of and as a byproduct of the act of decryption itself. This eliminates the need for any additional authentication process, and in some implementations can be achieved while adding no or substantially no additional burden to computational resources.

The current industry standard and common practice is decryption, then comparison of the hash or checksum of the decrypted text with the hash or checksum of the original plain text which was transmitted along with the cipher text. However, this conventional approach only protects against unintentional and innocent errors. As an example, if a nefarious actor is capable of altering the cipher text in a meaningful way, then the actor also has the capability to alter the transmitted hash or checksum to hide evidence of tampering.

To address these weaknesses, asymmetric key encryption signatures may be used to verify and authenticate. Asymmetric key encryption is very burdensome in additional time and processing resources, and substantially impacts the speed of encrypted communications, use of processor cycle, and use of network bandwidth. As a result, asymmetric key encryption is completely unsuitable for many instances of line speed data transmission over high speed modern networks.

As further example, a message sender using streaming ciphers or other ciphers to encrypt a plain text message uses a raw key or “root key” to generate a deterministic mature key, which is, in turn, used to encrypt the outgoing plain text message (e.g., typically in portions, such as one byte, word, or other sub-set of plain text at a time, which may be collectively referred to herein as a plain text portion or plain text block) usually using a cipher function or operator (e.g., such as the XOR native function). Upon receipt and decryption by a message recipient, the same shared raw key generates the same deterministic mature key on the recipient system, and the encrypted message can be decrypted on the recipient system using the same cipher function (e.g., such as the XOR native function). The above process provides no means for authentication or verification.

Using implementations of the disclosed novel technology, the generation of the deterministic mature key may be altered based upon current and prior encryption character(s)/portions (e.g., prior plain text portion, prior cipher text for plain text portion) as it is encrypted and decrypted, and as a result authentication becomes a trivial task and occurs as a byproduct of decryption. Varying streaming ciphers such as RC4, PiCypher, FISH, and ISAAC, as well as other streaming ciphers, block ciphers, and other cipher methods, benefit from such implementations by adding strong authentication of cipher text that occurs incidental to the basic function of the cipher and without substantial impact on computational resources. In such implementations, if even a single bit of the transmitted, encrypted data is altered, the deterministic mature key will be altered and thereby the resulting decrypted plain-text message will be garbled and usable.

In some implementations, a further authenticity feature may be implemented by appending a single arbitrary character value to the end of the plain-text message as it is encrypted to quantify the probability that any subsequent authenticity fault is organic or intended. When the mature key causes the last arbitrary character to be decrypted as a different character than expected, the bit size of that character value provides a quantifiable probability that this alteration was an organic error or an intended alteration.

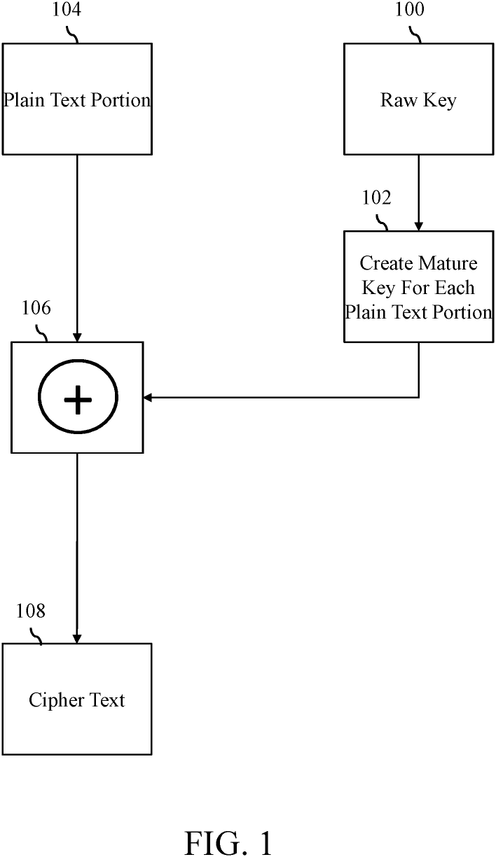

As additional example of the above, FIG. 1 illustrates a conventional approach for providing encrypted communication with a streaming cipher, such as has been described above. A shared raw key (100) is available to both sender and recipient, and is used to create (102) a mature key for each portion of the plain text that is to be encrypted. As each mature key is created, it is used with the corresponding portion of plain text (104) to create (e.g., using XOR or another cipher operation) (106) a corresponding cipher text (108). The cipher text (108) may then be transmitted to the recipient device, which is able to decrypt the data because it is configured to store the shared raw key, locally create a corresponding mature key, and perform the corresponding decipher operation (e.g., XOR). Because the creation of mature keys is deterministic, this approach is vulnerable to manipulation, and so may require additional steps or features such as asymmetric key authentication to mitigate risks of data loss or tampering.

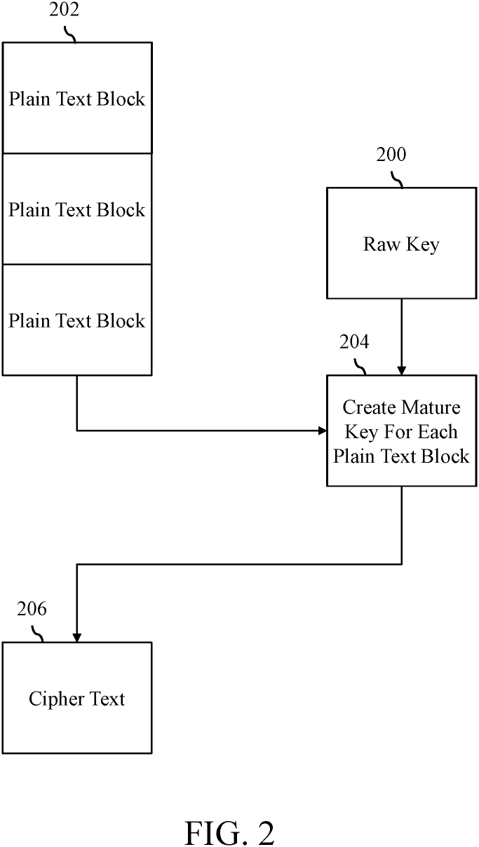

FIG. 2 illustrates a conventional approach for providing encrypted communication with a block cipher. While a block cipher approach is very different from a streaming cipher in a number of ways, they do share some concepts such as the use of a shared raw key (200), output of a cipher text (206), and local creation and use of a mature key (204) or its equivalent for specific portions of the plaint text message block(s) (202). As with the approach illustrated by FIG. 1, the illustrated block cipher approach may require asymmetric key authentication to mitigate the risks of data being corrupted or tampered with.

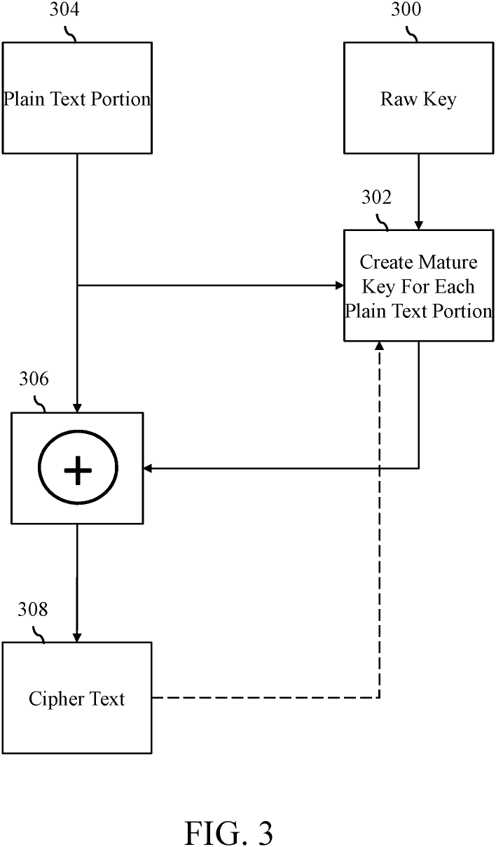

As an example of a novel encryption method as has been described above, FIG. 3 shows a set of steps that may be performed with a system to provide encrypted communication with a streaming cipher including an evolving mature key. In conventional approaches as described above, mature keys and their equivalents are deterministic, which allows each of the sender and recipient to locally and independently generate corresponding mature keys for use in encryption and decryption, but also introduces certain weaknesses into the process which may be exploited. Conversely, an evolving mature key is influenced by variable and dynamic factors, and so is functionally impossible to predict and/or intercept in a manner that would allow an intercepting party to decrypt the data into meaningful information, or modify the data in an undetectable way. As illustrated by FIG. 3, creation (302) of the mature key is dependent on the raw key (300), the plain text portion (304), and a prior character or portion’s cipher text (308), and may utilize a cipher operation (306) such as an XOR operation, or another cipher operation capable of accepting those inputs. Alternately, creation (302) of the mature key may instead be dependent only on the raw key (300) and the plain text portion (304), but need not include the prior character or portion’s cipher text (308), and may utilize a cipher operation (306) such as an XOR operation, or another cipher operation capable of accepting those inputs. Each of the sender and the recipient are able to locally create corresponding mature keys, because they have been involved in each step of the communication, but a party intercepting a partial data stream will not have information from the prior transaction (e.g., prior transaction cipher text, plain text portion) and so will be unable to determine the evolving mature key throughout the communication in order to interpret or modify its contents.

Notably, as one of the final steps of encrypting or decrypting each transmitted portion, the applicable system will create the evolving mature key that will be used for the encryption or decryption of the subsequent transmitted portion. Since the inputs that determine the evolving mature key are variable and unpredictable (e.g., message plain text portion, cipher text) for any party that is not the sender or recipient, a party intercepting the transmission will not have any predictable or deterministic information guiding their attempts to decrypt the data, meaning that the data also cannot be modified in an undetectable way.

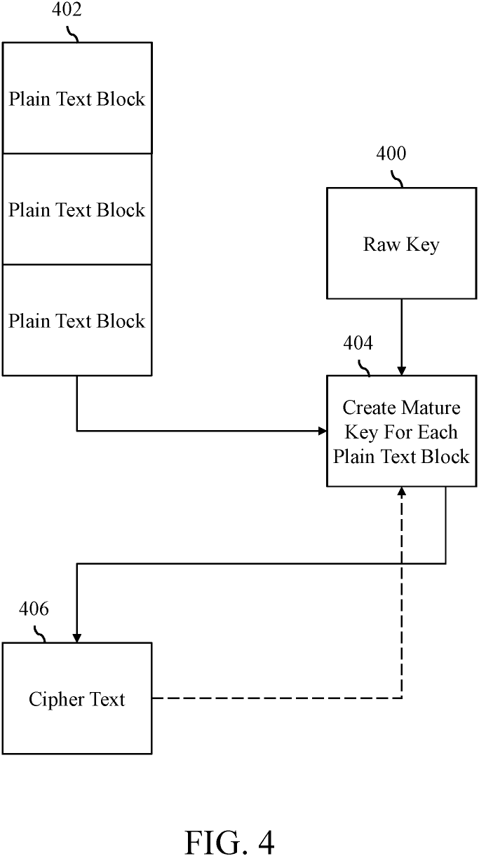

FIG. 4 shows a set of steps that may be performed with a system to provide encrypted communication with a block cipher including an evolving mature key (404), or its equivalent. Similarly to the steps shown in FIG. 3, the cipher text (406) created for a precedent transmitted portion is used as an input to creating (404) the mature key (404) for the subsequent transmitted portion. As with FIG. 3, the illustrated block cipher prevents an intercepting party from predicting, based on deterministic data or other guidance, the evolving mature (404) key since the cipher text (406) is variable and dynamic, and so any intercepted data cannot be undetectably modified. As with the example of FIG. 3, creation (404) of the mature key is dependent on the raw key (400), the plain text portion block(s) (402), and a prior character or portion’s cipher text (406). Alternately, creation of the mature key may instead be dependent on the raw key (400) and the plain text portion (402), but need not include the prior character or portion’s cipher text (406).

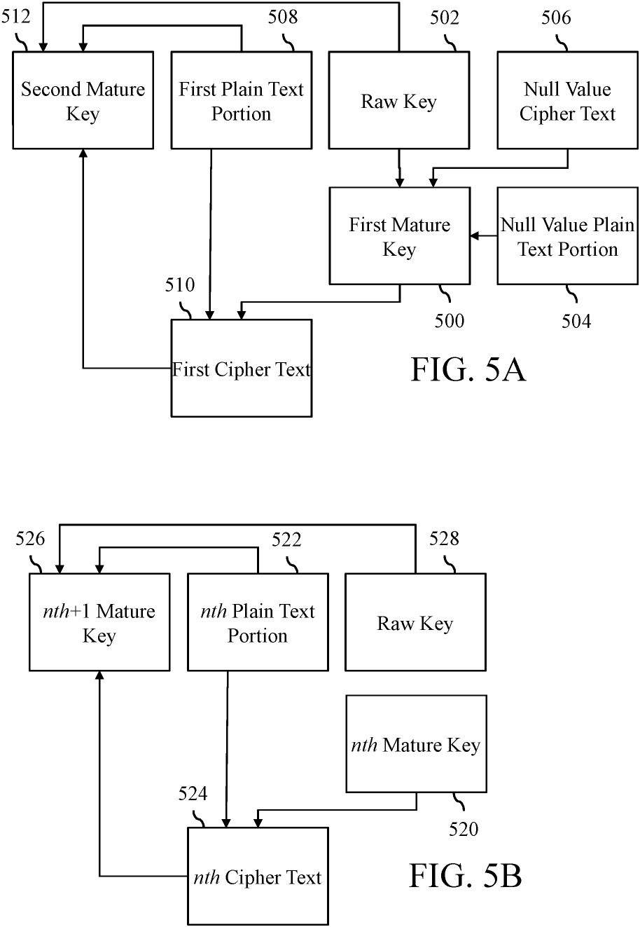

FIGS. 5A and 5B illustrate additional examples of the above. FIG. 5A shows inputs and outputs for a first transmitted portion of data in a sequence. The first mature key (500) (e.g., which may be alternately referred to as the first iteration or generation of an evolving mature key) is created based on the raw key (502), a null or other arbitrary value substituted for a zeroth plain text portion (504), and a null or other arbitrary value for a zeroth cipher text (506) (e.g., since this is the first transmitted portion in a sequence, there is not a previously created mature key to use, and there are not prior values for plain text portion or cipher text - so the first mature key is created normally). The first mature key (500) is then used with the first plain text portion (508) to create a first cipher text (510), which may be transmitted as an encrypted transmission of the first plain text portion (508). The system then creates a second mature key (512) (e.g., alternatively, a second iteration or generation of the evolving mature key) based on the raw key (502), the first cipher text (510), and the first plain text portion (508).

FIG. 5B shows inputs and outputs for an nth (e.g., second, third, so on) transmitted portion of data, following a first or an intervening transmitted portion of data such as that described in the context of FIG. 5A. The nth mature key (520) has already been created at a prior step (e.g., based on the raw key, the first cipher text, and the first plain text portion, as illustrated in FIG. 5A), and so is not recreated here. The nth plain text portion (522) and nth mature key (520) are used to create the nth cipher text (524), which may then be transmitted. The system then creates the nth+1 mature key (526) based on the raw key (528), nth cipher text (524), and the nth plain text portion (522), which will be usable as the mature key for a subsequently transmitted portion.

While the figures and descriptions have shown that an evolving mature key can be created based upon a raw key, prior cipher text, and prior plain text portion, some or all of the disclosed advantages can be achieved by using only one of the prior cipher text and prior plain text portion in combination with the raw key. For example, in some implementations the evolving mature key may be created based upon the raw key and the prior cipher text, or may be created based upon the raw key and the prior plain text portion, and this method will still provide unpredictable, non-deterministic, and self-authenticating encryption and decryption over a sequence of transmissions.

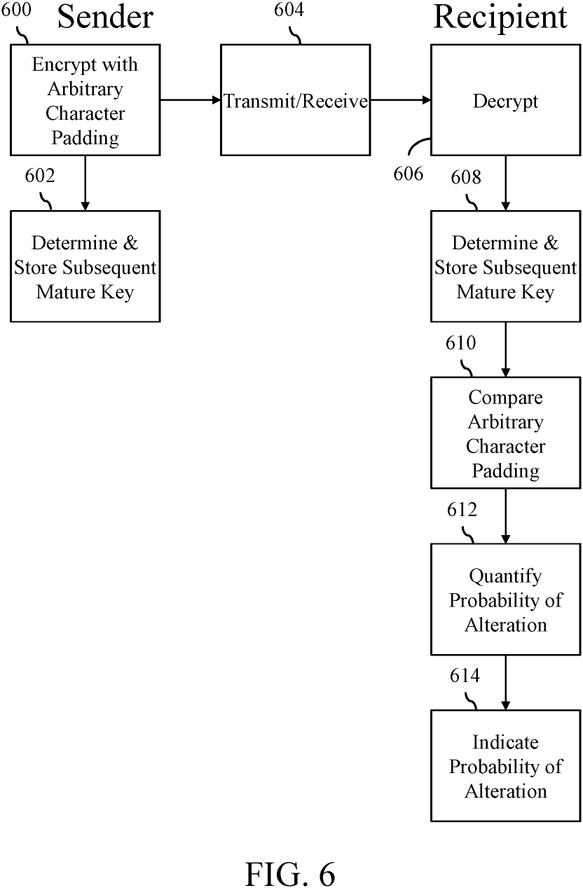

The above is further illustrated by FIG. 6, in the context of steps that may be performed by the sender and the recipient. When sending (604) a message portion, the sender may encrypt (600) the message portion, and may include an arbitrary character padding for recipient authentication purposes. When transmitting the cipher text, the sender may also determine (602) and store the evolving mature key for use with a subsequent portion transmission.

Upon receiving the cipher text, the recipient may decrypt (606) the cipher text using a previously created and stored mature key, and may also determine and store (608) the evolving mature key for use with a subsequent portion transmission. The recipient may also compare (610) the decrypted arbitrary character to the expected character, and if there is not a match the system may quantify (612) the probability that the message has been altered with a high degree of confidence. Where the probability of alteration exceeds a threshold indicating likely alteration, the system may also provide (614) an indication of the probability of alteration (e.g., an alarm, a notification to a system administrator, flagging of the message in question, etc.).

It should be understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

1. A set of software instructions for non-deterministic encrypted communication of a dataset between a first device and a second device, the set of software instructions configured to, when executed by a processor of the first device and for each text portion of a plurality of portions of the dataset:
(a) create an evolving mature key based on a raw key and a variable input comprising either:
(i) where that text portion is the first text portion, a zeroth text portion; or
(ii) a precedent text portion that immediately precedes that text portion;
(b) using a cipher function, encrypt that text portion based on that text portion and the evolving mature key to create a cipher text; and
(c) provide the cipher text to the second device;
wherein the cipher text is configured to be decrypted by the second device by, for each received text portion of a plurality of received text portions:
(i) locally creating the evolving mature key based on the raw key and the variable input; and
(ii) using the cipher function, locally decrypting the cipher text based on the evolving mature key and the variable input.

2. The software instruction of claim 1, further configured to, for each text portion of the plurality of portions, create the evolving mature key based on the raw key, the variable input, and a second variable input comprising either:
(i) where that text portion is the first text portion, a zeroth cipher text; or
(ii) a precedent cipher text that immediately precedes the cipher text;
wherein the cipher text is configured to be decrypted by the second device by, for each received text portion of a plurality of received text portions:
(i) locally creating the evolving mature key based on the raw key, the variable input, and the second variable input; and
(ii) using the cipher function, locally decrypting the cipher text based on the evolving mature key and the variable input.

3. The software instruction of claim 1, further configured to, for each text portion of the plurality of portions, using the cipher function, encrypt that text portion based on that text portion, an arbitrary character value appended to that text portion, and the evolving mature key to create the cipher text, wherein the cipher text is configured to be decrypted by the second device by, for each received text portion of a plurality of received text portions:
(i) locally creating the evolving mature key based on the raw key and the variable input;
(ii) using the cipher function, locally decrypting the cipher text based on the evolving mature key and the variable input; and
(iii) quantifying a probability of alteration based upon a comparison of a final character of that decrypted text portion and the arbitrary character value.

4. A method for non-deterministic encrypted communication of a dataset between a first device and a second device comprising, for each text portion of a plurality of portions of the dataset:
(a) creating an evolving mature key based on a raw key and a variable input comprising either:
(i) where that text portion is the first text portion, a zeroth text portion; or
(ii) a precedent text portion that immediately precedes that text portion;
(b) using a cipher function, encrypting that text portion based on that text portion and the evolving mature key to create a cipher text; and
(c) providing the cipher text to the second device;
wherein the cipher text is configured to be decrypted by the second device by, for each received text portion of a plurality of received text portions:
(i) locally creating the evolving mature key based on the raw key and the variable input; and
(ii) using the cipher function, locally decrypting the cipher text based on the evolving mature key and the variable input.

5. The method of claim 4, further comprising, for each text portion of the plurality of portions, creating the evolving mature key based on the raw key, the variable input, and a second variable input comprising either:
(i) where that text portion is the first text portion, a zeroth cipher text; or
(ii) a precedent cipher text that immediately precedes the cipher text;
wherein the cipher text is configured to be decrypted by the second device by, for each received text portion of a plurality of received text portions:
(i) locally creating the evolving mature key based on the raw key, the variable input, and the second variable input; and
(ii) using the cipher function, locally decrypting the cipher text based on the evolving mature key and the variable input.

6. The method of claim 4, further comprising, using the cipher function, encrypting that text portion based on that text portion, an arbitrary character value appended to that text portion, and the evolving mature key to create the cipher text, wherein the cipher text is configured to be decrypted by the second device by, for each received text portion of a plurality of received text portions:
(i) locally creating the evolving mature key based on the raw key and the variable input;
(ii) using the cypher function, locally decrypting the cipher text based on the evolving mature key and the variable input; and
(iii) quantifying a probability of alteration based upon a comparison of a final character of that decrypted text portion and the arbitrary character value.
